(19) United States
(12) Patent Application Publication
(10) Pub. No.: US 2025/0095061 A1
(43) Pub. Date: Mar. 20, 2025

(54) SYSTEMS AND METHODS FOR AUTOMATED LOAN AUTHORIZATION

(71) Applicant: The PNC Financial Services Group, Inc., Pittsburgh, PA (US)

(72) Inventors: Henry Kai-Ze CHAN, Chicago, IL (US); Richard LaVerne NILL, JR., Wexford, PA (US); Simrandeep Singh BAJAJ, McDonald, PA (US); Beth Marie KLEBACHA, Gibsonia, PA (US); Thakur Babu KONDASANI, Gastonia, NC (US); Reshma Kishore NANKANI, Glen Rock, NJ (US); Satish Kumar GADEY, Bloomington, MN (US)

(73) Assignee: The PNC Financial Services Group, Inc., Pittsburgh, PA (US)

(21) Appl. No.: 18/966,504

(22) Filed: Dec. 3, 2024

Related U.S. Application Data
(63) Continuation of application No. 18/503,379, filed on Nov. 7, 2023.
(60) Provisional application No. 63/480,826, filed on Jan. 20, 2023.

(51) Int. Cl. G06Q 40/03

(52) U.S. Cl. CPC G06Q 40/03

(57) ABSTRACT

Disclosed embodiments relate to systems and methods for automating loans based on a loan determination process. Techniques include receiving input data, determining whether the received input data matches a set of predetermined criteria, responsive to a determination that the received input data matches the predetermined criteria, setting user preferences, providing an interactive website interface, updating the website interface based on interactive fields, automatically determining whether to provide the requested loan, responsive to a determination to provide the requested loan, sending a loan amount to a bank account, and providing a status update to a user device.

### TECHNICAL FIELD

The present disclosure relates generally to systems and methods for automatically evaluating and authorizing loans based on user information.

### BACKGROUND

Accelerating the loan application and approval process is a priority for both borrowers and lenders. Previously, manual underwriting was the only way to disburse loans. Automation has streamlined loan processing by providing proactive communication to customers, accelerating data collection and processing, and reducing errors within the lending process. By creating a loan program for existing partners within a system, documents can be submitted, received, reviewed, and approved in a streamlined process. This saves time and money and reduces errors. It also improves the customer experience, allowing a new applicant to experience a seamless loan application process. Loan automation also provides faster, more accurate loan processing.

Lending relies on generating an economic benefit through funding individuals and entities, while ensuring a lender makes a profit, creates shareholder value, and mitigates risk. Assessing the creditworthiness of individuals and entities, requesting a loan, can present a challenge. The present solution streamlines and automates the lending process to help overcome these challenges. Loans can range in both size and complexity and traditional solutions that rely on manual underwriting methods and spreadsheets can be tedious to maintain, due to formula complexity and version control issues. There can also be issues with duplicating records of the same data or errors with data entry. By automating this process, lenders mitigate risk to ensure there are not data entry errors. Automated loans also lead to shorter lending cycles and allow lenders to consistently monitor the creditworthiness of borrowers, to assess whether borrowers are eligible for new loans or to refinance existing loans.

### SUMMARY

The disclosed embodiments describe a system for automating loan authorization to a user. In one embodiment, a system may include a memory storing instructions, and at least one processor configured to execute the stored instructions to perform operations for automating loan authorization. The operations may comprise receiving input data from a user comprising product parameters, contact information, and payment type setup for a loan application, determining whether the received input data matches a set of predetermined criteria, responsive to a determination that the received input data matches the predetermined criteria, setting one or more user preferences based on the received input data, providing an interactive website interface having a plurality of interactive fields, the interface including notification preferences, user preferences, authorization information, loan selections, and a loan amount, updating the website interface based on the interactive fields, automatically determining whether to provide the requested loan, responsive to a determination to provide the requested loan, sending the loan amount to a bank account, and providing a status update for the requested loan to the user device.

According to disclosed embodiments, the user preferences may include an indication of user types, wherein the user types include at least one of an operational user or an administrative user.

According to disclosed embodiments, the contact information may include an identity of the applicant, an email address, a telephone number, or a mailing address.

According to disclosed embodiments, the notification preferences may include notifications for at least one of batch applications, denied loan requests, invoice availability, or a request for required applicant information.

According to disclosed embodiments, the notification preferences may be set on an incremental time basis for each loan application, wherein the incremental time basis is at least one of a daily notification, a weekly notification, or a monthly notification.

According to disclosed embodiments, the authorization information may include at least one of financial disclosures, legal documentation, tax documentation, or identity verification.

According to disclosed embodiments, the loan selection may comprise a fixed rate or a variable rate.

According to disclosed embodiments, the operations may comprise, responsive to a determination not to provide the requested loan, sending a notification to the applicant and providing for display a user interface allowing the applicant to edit the loan application.

According to disclosed embodiments, the operations may further comprise providing, via the website interface, a table with the applicant's outstanding loans, wherein the interface includes at least one of an interest due date, an interest rate, an original loan balance, a current loan balance, an amortization rate, an amortization due, a maturity date, a last payment date, a last payment amount, a next payment amount, or a next payment date.

According to disclosed embodiments, an applicant may make a pre-payment through the website interface.

According to disclosed embodiments, an applicant may apply for a new loan.

According to disclosed embodiments, an applicant may apply for a loan re-extension through the website interface.

According to disclosed embodiments, the operations may further comprise an automated loan amortization schedule.

According to disclosed embodiments, the operations may further comprise routing the loan application for an automatic Know Your Customer (KYC) and Office of Foreign Assets Control (OFAC) check.

According to disclosed embodiments, the processor may be further configured to generate automated loan statements.

According to disclosed embodiments, the processor may be further configured to determine in which state the applicant resides and update the website interface based on the applicant's state of residence.

According to disclosed embodiments, the operations may further comprise determining that the applicant is a Florida resident and requiring Florida stamp tax forms and information.

Aspects of the disclosed embodiments may include non-transitory computer-readable media that store software instructions that, when executed by one or more processors, are configured for and capable of performing and executing one or more of the methods, operations, and the like consistent with the disclosed embodiments. Also, aspects of the disclosed embodiments may be performed by one or more processors that are configured as special-purpose processor(s) based on software instructions that are programmed with logic and instructions that perform, when executed, one or more operations consistent with the disclosed embodiments.

It is to be understood that both the foregoing general description and the following detailed description are exemplary and explanatory only, and are not restrictive of the disclosed embodiments, as claimed.

### BRIEF DESCRIPTION OF THE DRAWINGS

The accompanying drawings, which are incorporated in and constitute a part of this specification, illustrate disclosed embodiments and, together with the description, serve to explain the disclosed embodiments. In the drawings:

FIGS. 1A-1C illustrate exemplary conventional loan authorization processes.

FIGS. 2A-2B illustrate exemplary loan authorization processes, consistent with disclosed embodiments.

FIG. 3 illustrates an exemplary application of an automated loan authorization, consistent with disclosed embodiments.

FIG. 4 illustrates an example environment for performing an automated loan authorization, consistent with disclosed embodiments.

FIG. 5 illustrates an example flow diagram for automated loan authorization, consistent with disclosed embodiments.

FIG. 6 illustrates an example system environment for automating loan authorization to a user, consistent with disclosed embodiments.

FIG. 7 is a block diagram showing an exemplary computational device, consistent with the disclosed embodiments.

FIG. 8 illustrates an example loan determination process, including a determination to send the loan to a bank account, consistent with disclosed embodiments.

FIG. 9 is a flowchart illustrating an example loan determination process, consistent with the disclosed embodiments.

FIG. 10 is an ordered list of steps to be completed by the applicant wherein each step is required to apply for a loan, consistent with disclosed embodiments.

FIG. 11A illustrates an exemplary graphical user interface displaying comparative loan plan options, consistent with disclosed embodiments.

FIG. 11B illustrates an exemplary graphical user interface displaying a drop-down menu of frequently asked questions regarding the available loan plans, consistent with disclosed embodiments.

FIG. 12A illustrates an exemplary graphical user interface to visualize loan options information considering the Total Loan Amount, wherein the user can input a specified prepayment amount, consistent with disclosed embodiments.

FIG. 12B illustrates an exemplary graphical user interface to visualize a One Time Payment Authorization, wherein the interactive user interface allows the user to authorize the lending party to perform actions and collect data required for the acceptance of the loan prior to the first deposit, consistent with disclosed embodiments.

### DETAILED DESCRIPTION

In the following detailed description, numerous specific details are set forth in order to provide a thorough understanding of the disclosed example embodiments. However, it will be understood by those skilled in the art that the principles of the example embodiments may be practiced without every specific detail. Well-known methods, procedures, and components have not been described in detail so as not to obscure the principles of the example embodiments. Unless explicitly stated, the example methods and processes described herein are not constrained to a particular order or sequence, or constrained to a particular system configuration. Additionally, some of the described embodiments or elements thereof can occur or be performed simultaneously, at the same point in time, or concurrently. While several illustrative embodiments are described herein, modifications, adaptations and other implementations are possible. For example, substitutions, additions, or modifications may be made to the components illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope is defined by the appended claims.

Reference will now be made in detail to the disclosed embodiments, examples of which are illustrated in the accompanying drawings.

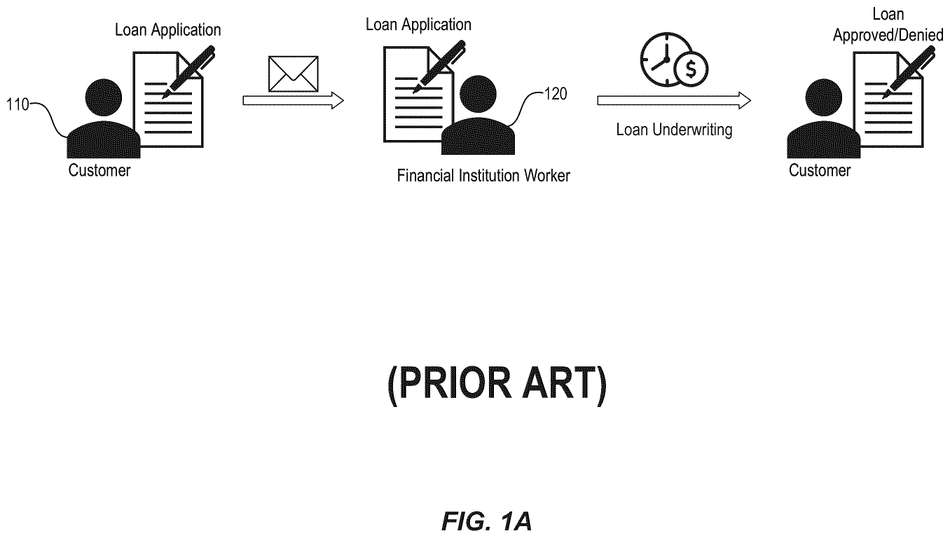

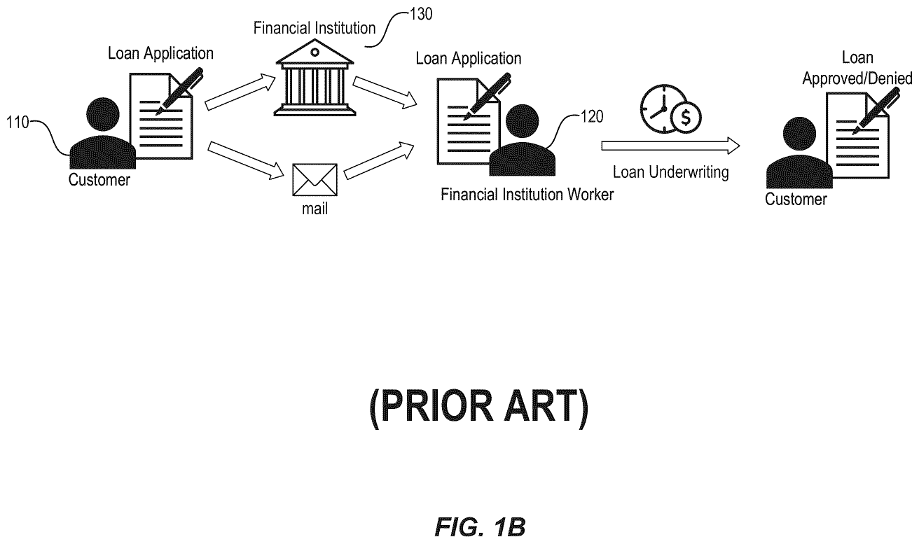

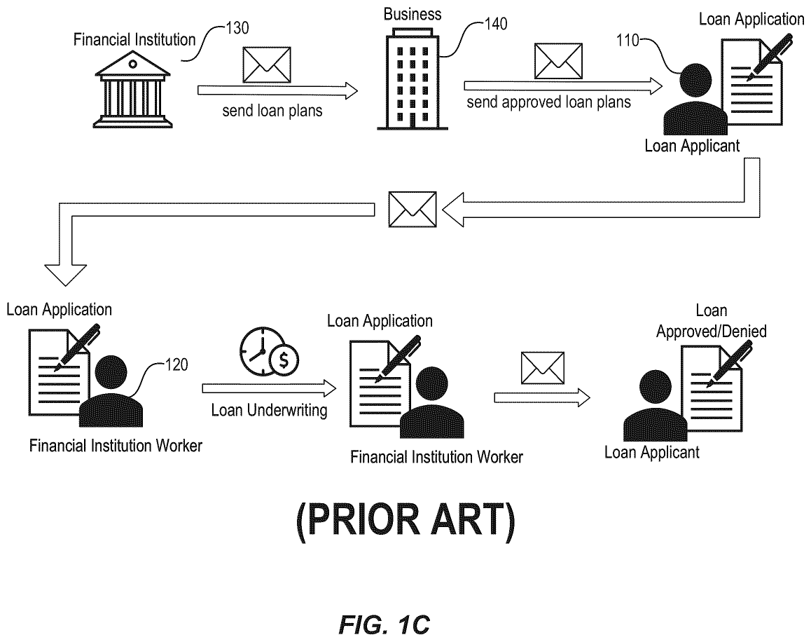

FIGS. 1A-1C illustrate exemplary conventional loan authorization processes. As illustrated in FIG. 1A, a customer 110, which may be an individual, financial institution, or an organization, may wish to apply for a loan. The customer 110 may fill out a loan application on paper and mail the loan application to a financial institution worker 120, which may be a loan officer, loan processor, loan underwriter, or any other individual who works for a financial institution 130 and works with loan applications. The financial institution worker 120 may rely on or utilize manual underwriting methods to process the loan application, which may be timely and costly. The loan application may be mailed back to the customer 110 after the financial institution worker 120 determines approval or rejection.

As illustrated in FIG. 1B, the customer 110 may physically bring their loan application with themselves to a financial institution 130, after which a financial institution worker 120 may begin the manual loan underwriting process.

As illustrated in FIG. 1C, a financial institution 130 may send one or more loan plans to a business 140. The business 140 may approve a number of the loan plans. The business 140 may request loan plans on behalf of and/or for an individual 110 associated with the business. As used in FIG. 1C, an individual 110 who applies for a loan may be referred to as a “loan applicant.” The individual 110 may include a partner who wishes to take out a loan to pay their capital or equity buy-in. The loan applicant 110 may undergo a loan application process as described above with reference to FIGS. 1A and 1B.

More specifically, partner loans are a type of loan offered to partners of professional services firms to fund a capital buy-in in the firm. A typical current partner loan process workflow involves a long and complex paper trail involving multiple entities.

For example, term sheets and loan plans may be mailed, physically or digitally, between a firm and a financial institution until a set of loan plans are agreed upon by both parties. The set of loan plans may be provided to partners of a firm by the firm on paper or digitally. The partner may have to sort through many pages of loan documents to compare different loan plans to find the loan plan they wish to pursue. Then the partner may print or download the selected loan plan, fill out the associated loan plan application, and mail, physically or digitally, the associated loan plan application to the financial institution. The financial institution may then manually sort and review the completed loan application, which may create a possibility of error. The partner may be unaware of the status of their loan application until a final approval or rejection is made. If the final decision is a rejection, the partner may have to restart the loan application process, the result of which may negatively affect the relationship between the firm and financial institution.

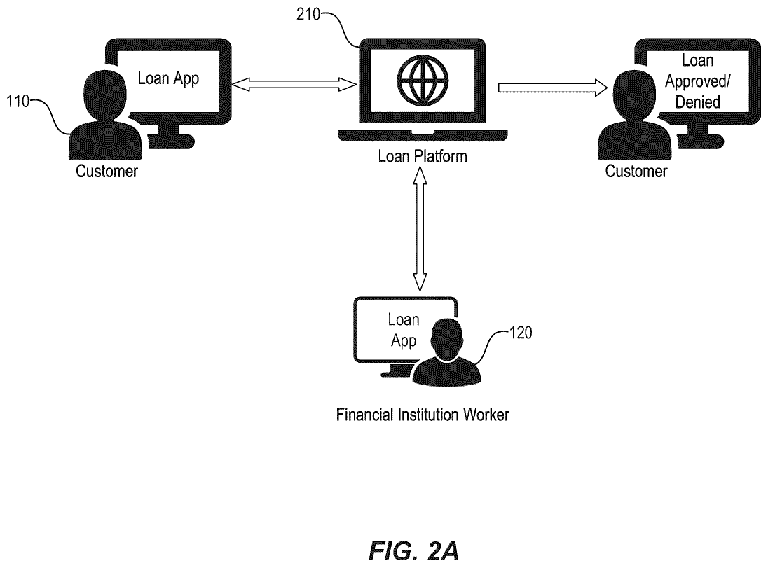

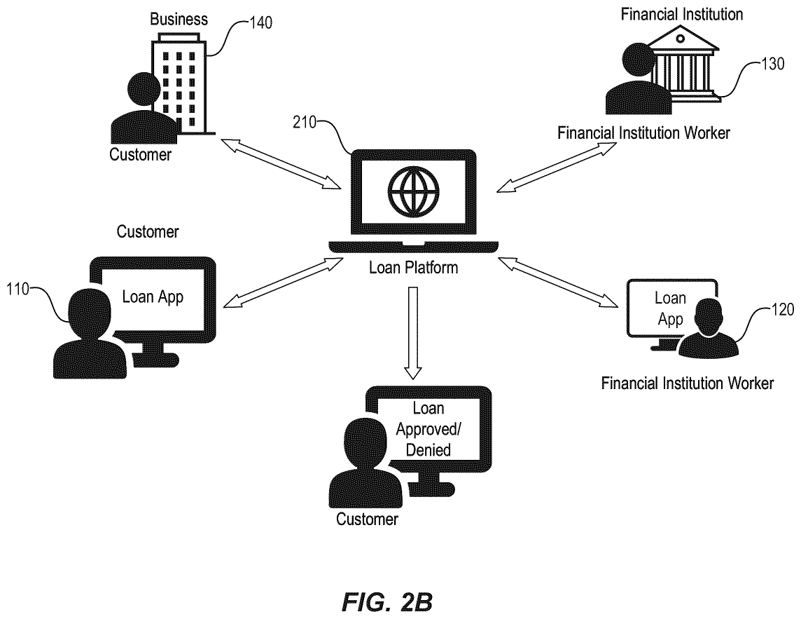

FIGS. 2A-2C illustrate exemplary loan authorization processes. As illustrated in FIG. 2A, a loan platform 210 may be configured to be used by both a customer 110 and a financial institution worker 130. Loan platform 210 may be a web-based application. Further, loan platform 210 may be configured to provide a loan application to a customer 110. The loan application may be configured to allow a financial institution worker 120 to access a loan application. Loan platform 210 may be configured to automate the loan underwriting process to provide a determination on a loan application.

As illustrated in FIG. 2B, loan platform 210 may be further configured to be used by a business 140 and a financial institution 130. Business 140 and financial institution 130 may use loan platform 210 to exchange and agree upon loan plan options. Business 140 may use loan platform 210 to access or modify loan applications of customer 110.

More specifically, loan platform 210 may be configured for partner loans and may involve a single platform through which a financial institution, firm, and partner can access, apply for, and track the progress of partner loans. A partner loan platform streamlines and automates the onboarding and ongoing administration for partners; the approvals and ongoing administration by firms; and the KYC review, funding, booking, and ongoing administration by the financial institution. By consolidating all documents to a single platform, automated processes may be implemented to reduce or eliminate manual loan approval processes. This digital solution provides a reduction in time, money, and complexity over the existing partner loan process for all parties involved, which may result in increased business and profits for a financial institution and a satisfied customer.

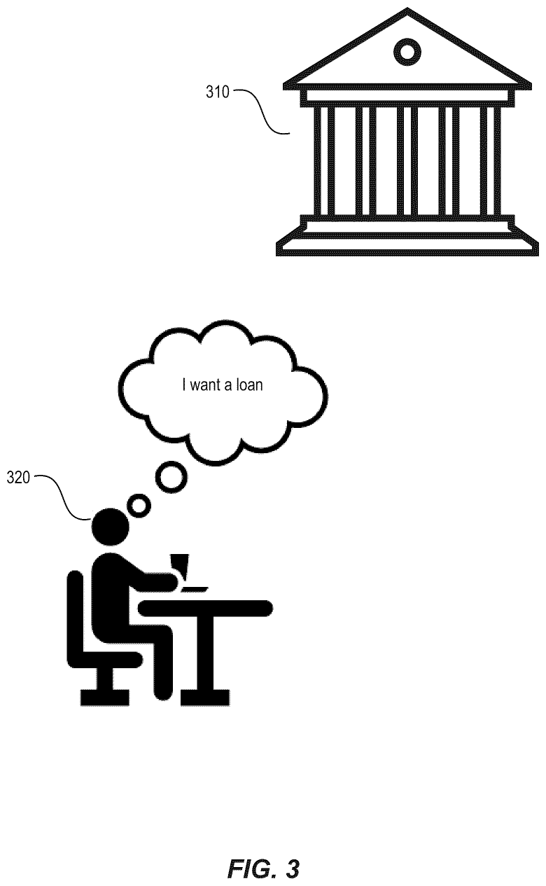

FIG. 3 illustrates an exemplary application of an automated loan authorization, consistent with disclosed embodiments. As illustrated in FIG. 3, entity 310, which may be an individual, a financial institution, or an organization, may offer loans. Person 320, which also may be an individual, may want a loan. As illustrated in FIG. 3, individual 320 may wish to apply for a loan with entity 310. The systems and methods disclosed herein may make sure that the loan application process is performed quickly through automation, while also allowing entities 310 and 320 to ensure that the process satisfies their specific needs. While FIG. 3 only illustrates one person 320 and one entity 310, the disclosed systems and methods may be applicable to any number of persons 320, entities 310, or any other persons or entities consistent with the present disclosure.

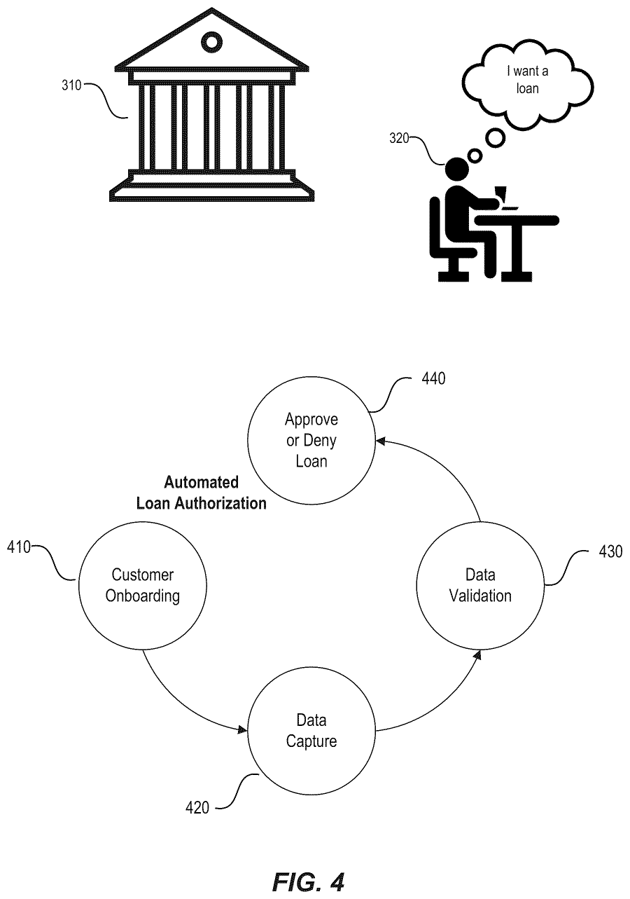

FIG. 4 illustrates an example flow environment for performing automated loan authorization, consistent with the disclosed embodiments. As shown in FIG. 4, there may be an automated loan authorization system to implement the loan needs illustrated in FIG. 3.

As illustrated in FIG. 4, the automated loan authorization may comprise a variety of steps. These steps may be performed in the order illustrated in FIG. 4 or may be performed in a different order. The embodiment shown in FIG. 4 is merely illustrative.

At customer onboarding step 410, a customer, such as person 320, may be onboarded. In some embodiments, this may be an existing customer. In other embodiments, this may be a new customer. Automated loan authorization onboarding for a customer may include receiving information associated with the customer, such as identifying information. Customers may provide documents and information for verification before opening an account or verify their own information for those who already have accounts.

At data capture step 420, the data from the documents and information provided at customer onboarding 410 may be captured. In some embodiments, this may be a digital capture of information to automatically fill the required information for the automated loan authorization process.

At data validation step 430, the information provided may be validated against a database of information to confirm a customer's identity. Further, the information provided may be automatically compared against a set of predetermined criteria to determine authorization.

At approve or deny loan step 440, the loan application for a customer may be automatically approved or denied based on the results of data validation step 430.

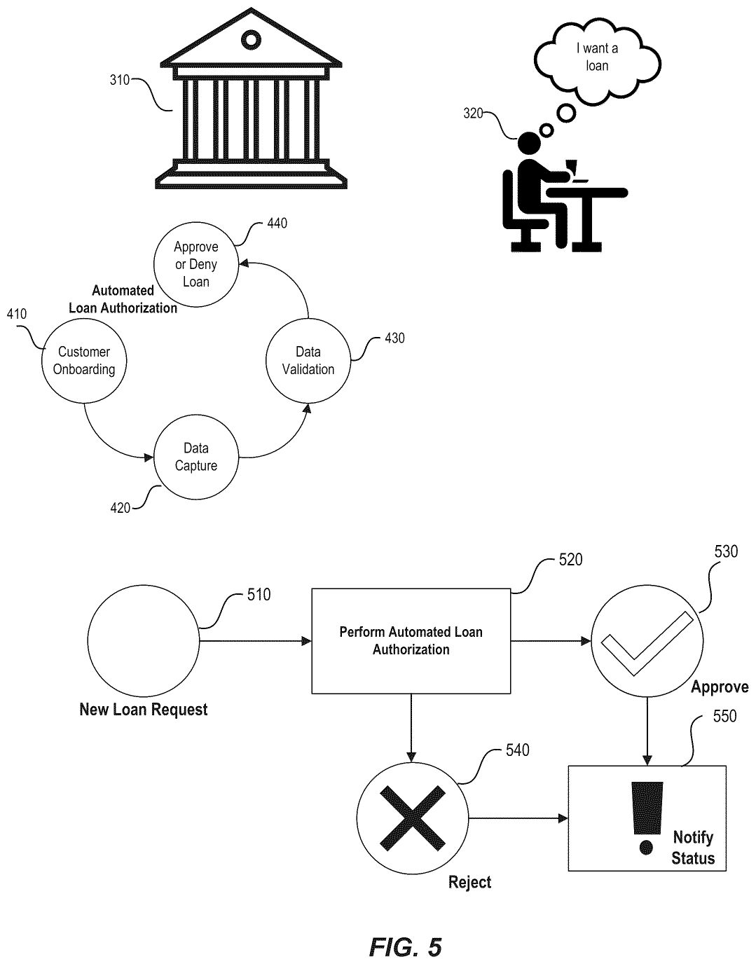

FIG. 5 illustrates an example flow diagram for automated loan authorization, consistent with the disclosed embodiments. As illustrated in FIG. 5, the elements from FIG. 3 and FIG. 4 for automated loan authorization may be incorporated into the environment for automated loan authorization. As illustrated in FIG. 5, at new loan request step 510, a new loan request may be initiated. At perform automated loan authorization step 520, the processing and verification checks may be performed, consistent with the disclosed embodiments. The automated loan authorization may result in approval (at approve step 530) or rejection (at reject step 540) of the new loan request, consistent with disclosed embodiments. If the automated loan authorization is approved (at approve 530) or rejected (at reject 540), there may be a notify status step 550 to notify the user that the process was either approved or not approved, respectively.

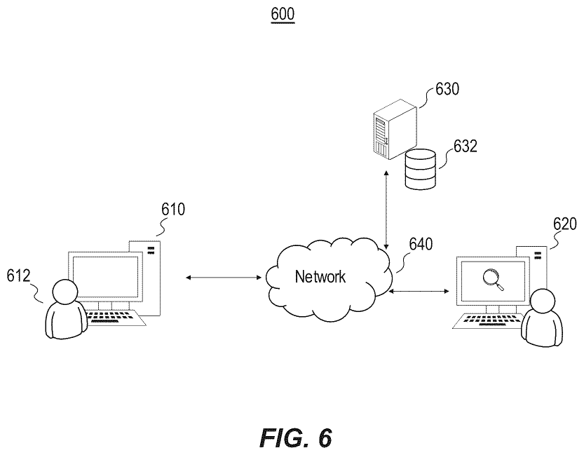

FIG. 6 illustrates an exemplary system environment 600 for automating loan authorization to a user, consistent with the disclosed embodiments. System environment 600 may include one or more financial institution endpoint devices 610, one or more user endpoint devices 620, and one or more computing devices 630, as shown in FIG. 6. System environment 600 may represent a system or network environment in which activities of a user 612 on financial institution endpoint device 610 are recorded and stored on computing device 630. A user 612 may then view these recordings on user endpoint device 620. In some embodiments, user 612 may be a partner at a business, company, or firm who wants a loan. A partner may involve an employee of a business, company, or firm who has been promoted to a senior position and may hold a significant ownership stake in the business, company, or firm. In some embodiments, the loan may be used to pay for, either in part or in full, an equity buy-in at the partner's company. In other embodiments, the loan may be a loan to a business as a trusted partner that allows members/affiliates of the trusted partner to benefit from the credit line. In some embodiments, a partner has a unique firm identifier associated with the partner's company. In some embodiments, the unique firm identifier is a six digit/letter code associated with the company. In some embodiments, the unique firm identifier is associated with the loan terms. The unique firm identifier may be used to streamline the automated loan authorization process. The unique firm identifier may be used to automatically associate a partner with a company, loan terms, or any other information associated with the partner's identity or loan application. The recording, transmission, and storage of the recorded user activity may be performed in a secure manner, such that only financial endpoint device 610 and user endpoint device 620 may have access to the recorded activity.

The various components of system 600 may communicate over a network 640. Such communications may take place across various types of networks, such as the Internet, a wired Wide Area Network (WAN), a wired Local Area Network (LAN), a wireless WAN (e.g., WiMAX), a wireless LAN (e.g., IEEE 802.11, etc.), a mesh network, a mobile/cellular network, an enterprise or private data network, a storage area network, a virtual private network using a public network, a nearfield communications technique (e.g., Bluetooth, infrared, etc.), or various other types of network communications. In some embodiments, the communications may take place across two or more of these forms of networks and protocols. While system environment 600 is shown as a network-based environment, it is understood that in some embodiments, one or more aspects of the disclosed systems and methods may also be used in a localized system, with one or more of the components communicating directly with each other.

User endpoint device 620 may be configured such that user 612 may access a protected navigation location through a browser or other software executing on user endpoint device 620. As used herein, a protected navigation location may be any network location deemed sensitive, e.g., a network location containing customer identification information. A protected navigation location may also refer to having one or more security protocols to authenticate a user trying to access the location. Activity of a user at the network location may be audited to provide increased accountability for the user. The increased accountability for a user may include providing a documented history of the user's actions, enabling traceability, deterring misconduct, attributing responsibility for issues, offering performance insights, ensuring legal compliance, and promoting transparency. For example, a protected navigation location may include a particular URL (or URL domain, etc.), a network location internal to an organization, or any other sensitive network location. User endpoint device 620 may include any form of computer-based device or entity through which user 612 may access a protected navigation location. For example, user endpoint device 620 may be a personal computer (e.g., a desktop or laptop computer), a mobile device (e.g., a mobile phone or tablet), a wearable device (e.g., a smart watch, smart jewelry, implantable device, fitness tracker, smart clothing, head-mounted display, etc.), an loT device (e.g., smart home devices, industrial devices, etc.), or any other device that may be capable of accessing web pages or other network locations. In some embodiments, user endpoint device 620 may be a virtual machine (e.g., based on AWS™, Azure™, IBM Cloud™, etc.), container instance (e.g., Docker™ container, Java™ container, Windows Server™ container, etc.), or other virtualized instance. Using the disclosed methods, activity of user 612 through user endpoint device 620 may be monitored and recorded by a browser extension executing on user endpoint device 620. In other embodiments, activity of a user 612 through user endpoint device 620 may be monitored and recorded by an external program executing on financial institution endpoint device 610 or computing device 630.

User endpoint device 620 may communicate with computing device 630 through network 640. For example, user endpoint device 620 may transmit recorded activity of user 612 to computing device 630. Computing device 630 may include any form of remote computing device configured to receive, store, and transmit data. For example, computing device 630 may be a server configured to store files accessible through a network (e.g., a web server, application server, virtualized server, etc.). Computing device 630 may be implemented as a Software as a Service (SaaS) platform through which software for auditing recorded user activity may be provided to an organization as a web-based service.

Financial institution endpoint device 610 may similarly communicate with computing device 630 through network 640. For example, financial institution endpoint device 610 may present the recorded activity of user 612 and request update of loan application to computing device 630.

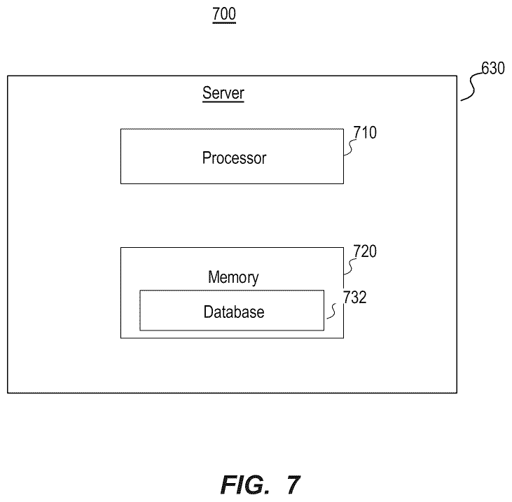

FIG. 7 is a block diagram 700 showing an example computing device 630, consistent with the disclosed embodiments. As described above, computing device 630 may be one or more devices configured to allow data to be received and/or transmitted by system 600 (e.g., a server, etc.) and may include one or more dedicated processors and/or memories. For example, computing device 630 may include a processor (or multiple processors) 710, and a memory (or multiple memories) 720, as shown in FIG. 7. Computing device 630 may include one or more digital and/or analog devices that allow computing device 630 to communicate with other machines and devices, such as other components of system 600. Computing device 630 may include one or more input/output devices. Computing device 630 may include a screen for displaying communications to a user. In some embodiments computing device 630 may include a touch screen. Computing device 630 may include other components known in the art for interacting with a user. Computing device 630 may also include one or more digital and/or analog devices that allow a user to interact with system 600, such as touch-sensitive area, keyboard, buttons, or microphones.

Processor 710 may take the form of, but is not limited to, one or more integrated circuits (IC), including application-specific integrated circuit (ASIC), microchips, microcontrollers, microprocessors, embedded processor, all or part of a central processing unit (CPU), graphics processing unit (GPU), digital signal processor (DSP), field-programmable gate array (FPGA), server, virtual server, system on an chip (SOC) or other circuits suitable for executing instructions or performing logic operations. Furthermore, according to some embodiments, processor 710 may be from the family of processors manufactured by Intel®, AMD®, Qualcomm®, Apple®, NVIDIA®, or the like. The processor 710 may also be based on the ARM architecture, a mobile processor, or a graphics processing unit, etc. The disclosed embodiments are not limited to any type of processor configured in computing device 630. In some embodiments, processor 710 may be a special purpose processor configured to perform one or more of the operations described below.

Memory 720 may include one or more storage devices configured to store instructions used by the processor 710 to perform functions related to computing device 630. The disclosed embodiments are not limited to particular software programs or devices configured to perform dedicated tasks. For example, the memory 720 may store a single program, such as a user-level application, that performs the functions associated with the disclosed embodiments, or may comprise multiple software programs. Additionally, the processor 710 may, in some embodiments, execute one or more programs (or portions thereof) remotely located from computing device 630. Furthermore, memory 720 may include one or more storage devices configured to store data for use by the programs. Memory 720 may include, but is not limited to a hard drive, a solid-state drive, a CD-ROM drive, a peripheral storage device (e.g., an external hard drive, a USB drive, etc.), a network drive, a cloud storage device, or any other storage device.

In some embodiments, memory 720 may include a database 632 as described above. Database 632 may be included on a volatile or non-volatile, magnetic, semiconductor, tape, optical, removable, non-removable, or other type of storage device or tangible or non-transitory computer-readable medium. Database 632 may also be part of computing device 630 or separate from computing device 630. When database 632 is not part of computing device 630, computing device 630 may exchange data with database 632 via a communication link. Database 632 may include one or more memory devices that store data and instructions used to perform one or more features of the disclosed embodiments. Database 632 may include any suitable databases, ranging from small databases hosted on a work station to large databases distributed among data centers. Database 632 may also include any combination of one or more databases controlled by memory controller devices (e.g., server(s), etc.) or software. For example, database 632 may include document management systems, Microsoft SQL™ databases, SharePoint™ databases, Oracle™ databases, Sybase™ databases, other relational databases, or non-relational databases, such as mongo and others. In some embodiments, computing device 630 may include one or more input/output devices, communications devices, displays, and/or other interfaces (e.g., server-to-server, database to-to-database, or other network connections).

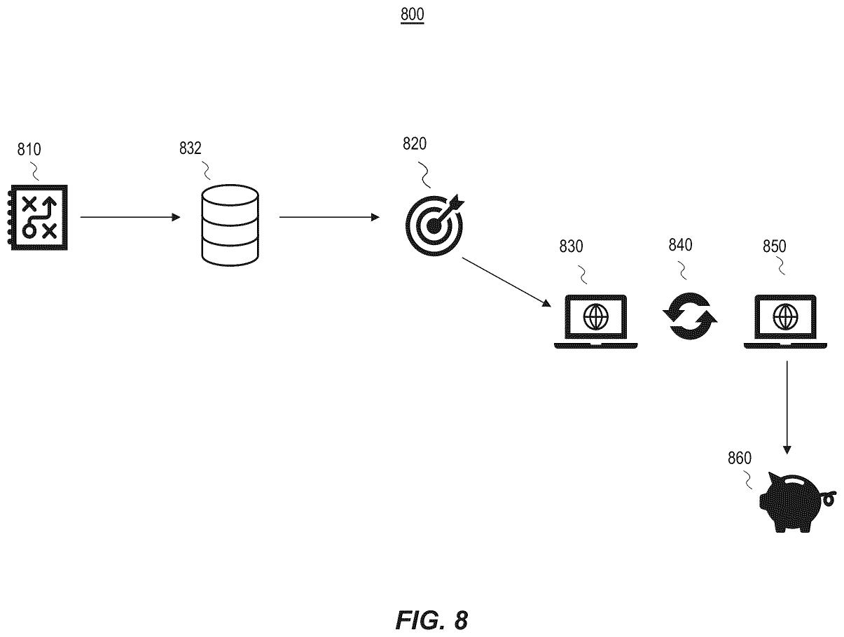

FIG. 8 illustrates an example loan determination process 800, including a determination to send the loan to a bank account, consistent with disclosed embodiments. In some embodiments, database 632 may receive input data 810 via a network 640 as described above. In some embodiments, the input data may be received from a user device. In some embodiments, input data 810 may comprise product parameters, contact information, and payment type setup for a loan application. In some embodiments, contact information may include an applicant's identity, name, phone number, social security number, email address, or mailing address. In some embodiments, payment type setup may comprise setting up mobile payments, or electronic bank transfer payments. In some embodiments, database 632 may confirm that input data 810 matches at least one of predetermined criteria 820 by comparing input data 810 against a list of acceptable inputs that may be determined by an administrative user. In some embodiments, the predetermined criteria 820 may include confirming an applicant is a United States citizen. In some embodiments, the predetermined criteria 820 may include confirming an applicant resides in the United States. In some embodiments, the predetermined criteria 820 may include passing a customer identification program. In some embodiments, passing the customer identification program includes confirming the contact information provided is correct. In some embodiments, the predetermined criteria 820 may include a minimum credit score. In some embodiments, the predetermined criteria 820 may include a minimum income. In some embodiments, the predetermined criteria 820 may include a maximum debt level. In some embodiments, the predetermined criteria 820 may include applicant collateral. In some embodiments, process 800 may end if input data 810 does not match at least one of predetermined criteria 820. In some embodiments, if input data 810 matches at least one of predetermined criteria 820, a website interface 830 may appear for user 612. In some embodiments, website interface 830 may contain a plurality of interactive fields. In some embodiments, at update 840, the website interface may update based on the plurality of interactive fields and display at updated website interface 850. In other embodiments, the website interface may not update. In some embodiments, responsive to a determination to provide the loan based on input data 810, process 800 may send the loan amount to bank account 860.

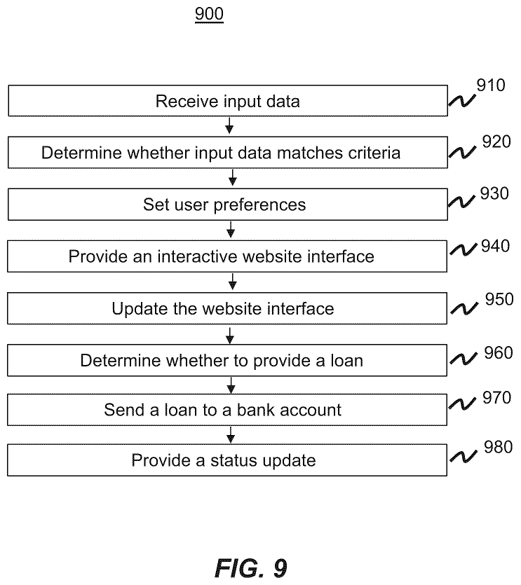

FIG. 9 is a flowchart showing an example process 900 for loan determination and authorization, consistent with disclosed embodiments. Process 900 may be performed by at least one processing device of a server, such as processor 710, as described above. In some embodiments, process 900 may be performed by at least one user device, connected to system 600. In some embodiments, a non-transitory computer readable medium may contain instructions that when executed by a processor cause the processor to perform process 900. Further, process 900 is not necessarily limited to the steps shown in FIG. 9, and any steps or processes of the various embodiments described throughout the present disclosure may also be included in process 900, including those described above with respect to FIGS. 6-8.

In step 910, process 900 may include receiving input data. In some embodiments, the input data may be received from a user device. In some embodiments, the input data may comprise product parameters, contact information, and payment type setup for a loan application. In some embodiments, contact information may include an applicant's identity, name, phone number, social security number, email address, or mailing address. In some embodiments, payment type setup may comprise setting up mobile payments, cash payments, automatic withdrawals, credit card payments, wire transfer, or electronic bank transfer payments. In some embodiments, the loan application may be for a personal loan, a business loan, or any other kind of loan.

In step 920, process 900 may include determining whether the received input data matches a set of predetermined criteria. In some embodiments, the predetermined criteria may include confirming an applicant is a United States citizen. In some embodiments, the predetermined criteria may include confirming an application resides in the United States. In some embodiments, the predetermined criteria may include passing a customer identification program. In some embodiments, passing the customer identification program includes confirming the contact information provided is correct. In some embodiments, the predetermined criteria may include a minimum credit score. In some embodiments, the predetermined criteria may include a minimum income. In some embodiments, the predetermined criteria may include a maximum debt level. In some embodiments, the predetermined criteria may include applicant collateral. In some embodiments, if the received input data does not match at least one of the predetermined criteria, process 900 may return an error. In other embodiments, if the received input data does not match at least one of the predetermined criteria, process 900 may not proceed to step 930. In other embodiments, if the received input data does not match at least one of the predetermined criteria, process 900 may not fund the loan. In some embodiments, at step 920, process 900 may determine that the matching has passed, failed, or is pending. In some embodiments, responsive to a determination not to provide the application at step 920, process 900 may send a notification to a user. Further, responsive to a determination not to provide the application at step 920, process 900 may provide for displaying a user interface allowing a user to edit the application.

In step 930, process 900 may, in response to a determination that the received input data matches at least one of the predetermined criteria, set one or more user preferences based on the received input data. In some embodiments, the user preferences may include a loan amount, a loan term, bank account information, tenure, maturity date, index rate for interest, credit rate, amortization rate, and an interest rate. In some embodiments, process 900 sets user preferences based on predefined options without further customization. In other embodiments, process 900 provides additional customization for refinanced loans. In some embodiments, the user preferences may include an indication of user types, wherein the user types include at least one of an operational user or an administrative user. In some embodiments, an administrative user may have greater privileges within system 600 than an operational user.

In step 940, process 900 may include providing an interactive website interface with a plurality of interactive fields. In some embodiments, the interface may include notification preferences, authorization information, loan selections, and a loan amount. In some embodiments, the notification preferences include notifications for at least one of batch applications, denied loan requests, invoice availability, or a request for required applicant information. In some embodiments, notification preferences may be sent on an incremental time basis for each location application, wherein the incremental time basis is at least one of a daily notification, a weekly notification, or a monthly notification. In other embodiments, an applicant may select to not have an incremental time basis notification. In some embodiments, the authorization information includes at least one of financial disclosures, legal documentation, tax documentation, or identity verification. In some embodiments, authorization information includes a government ID such as a driver's license, social security card, passport, passport card, state-issued identification card or military-issued identification card. In some embodiments, the loan selection comprises a fixed rate or a variable rate.

In step 950, process 900 may include updating the website interface based on the interactive fields. In some embodiments, based on the updating at step 950, the website interface may include a table with the applicant's outstanding loans. In some embodiments, the table may contain information displayed on the interface that pertains to at least one of: an interest due date, an interest rate, an original loan balance, a current loan balance, an amortization rate, an amortization due, a maturity date, a last payment date, a last payment amount, a next payment amount, or a next payment date. In some embodiments, process 900 may present an automated loan amortization schedule on the website interface. In some embodiments, process 900 may generate automated loan statements.

In some embodiments, an applicant may make a pre-payment through the website interface. In other embodiments, an applicant may apply for a new loan through the website interface. In other embodiments, an applicant may apply for a loan re-extension through the website interface.

In some embodiments, process 900 includes routing the loan application to an automatic Know Your Customer (KYC) check. In other embodiments, process 900 routes the loan application to the Office of Foreign Assets Control (OFAC) for a routine check. In some embodiments, the KYC check and OFAC check may return one of a pass, fail, or subject to further review response. In some embodiments, if the KYC check or the OFAC check returns a fail response, process 900 may not proceed to step 960. In other embodiments, if the KYC check or the OFAC check returns a fail response, process 900 may not fund the loan.

In some embodiments, process 900 may determine in which state or jurisdiction an applicant resides and may update the website interface based on the applicant's state or jurisdiction of residence. In some embodiments, process 900 may determine whether the applicant is a Florida resident. In some embodiments, upon determining that an applicant is a Florida resident, process 900 may require Florida stamp tax forms and information.

In step 960, process 900 may include automatically determining whether to provide the requested loan.

In step 970, process 900 may include, in response to a determination to provide the requested loan, sending the loan amount to a bank account. In some embodiments, the bank account is linked to the payment type setup. In some embodiments, if a determination is made not to provide the requested loan, process 900 may include sending a notification to the applicant. In some embodiments, an applicant may edit the loan applicant on the website interface.

In step 980, process 900 may include providing a status update for the requested loan to the user device. In some embodiments, the status update may be set in notification preferences by an applicant.

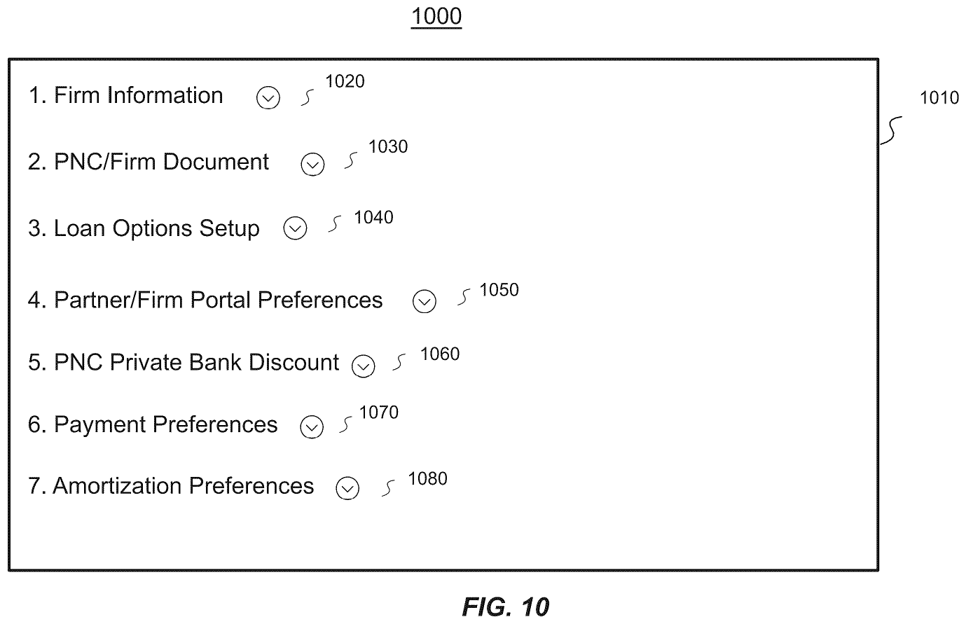

FIG. 10 is an ordered list of steps 1000 to be completed by a customer representative of a company wherein each step is required to set up loan options for employees of the company, consistent with disclosed embodiments. The customer representative of a company may be an individual or group of individuals. The loan applications may be set up such that employees of the company may select from the set-up loan options which loan option they want to pursue. Steps 1000 may be performed by at least one processing device of a server, such as processor 710, as described above. In some embodiments, steps 1000 may be performed by at least one user device, connected to system 600. In some embodiments, a non-transitory computer readable medium may contain instructions that when executed by a processor cause the processor to perform steps 1000. Further, steps 1000 is not necessarily limited to the steps shown in FIG. 10, and any steps or processes of the various embodiments described throughout the present disclosure may also be included in steps 1000, including those described above with respect to FIGS. 6-9. In some embodiments, steps 1000 may be displayed in a display window 1010.

In step 1020, a user may be able to configure firm information. In some embodiments, firm information may include a firm's name, a firm's ID, a firm's funding size, or firm user information. In some embodiments, a firm's funding size may include options for a small funding size of less than $10 million or a large funding size of $30 million. In some embodiments, firm user information may include a first name, a last name, a mobile number, a contact email, or user role. In some embodiments, a user role may include operational user, administrative user, read only user, or contact. A contact may be the main point of contact for the company to a loan provider. In some embodiments, a user may be able to add or remove any number of additional users.

In step 1030, a user may be able to view and/or upload PNC/firm documents. In some embodiments, PNC/firm documents may include an acknowledgement letter, a direction letter, and an administrative user list. In some embodiments, a user may configure each document to be viewable by an administrative user and/or a loan applicant.

In step 1040, a user may be able to view and/or configure loan options. In some embodiments, loan options may include loan name, use of proceeds, partner type, tenor, fixed versus floating rate index, credit spread, additional information, renewal options, minimum loan amount, interest payment dates, and prepayment. In some embodiments, loan name may be created by a user. In some embodiments, use of proceeds may include business purpose or personal purpose. In some embodiments, partner type may include a fund's general partner, a sponsor-affiliated special limited partner able to benefit from a credit line while streamlining the loan documentation process, or a management company. In some embodiments, tenor may include number of years, months, or days. In some embodiments, tenor may further include an option to override tenor with maturity date. In some embodiments, a user may select if the loan uses a floating rate index or a fixed rate index. In some embodiments, a user may further configure a minimum rate or minimum base rate associated with the floating rate index or fixed rate index. In some embodiments, a user may input additional information, which may include a description of any information regarding the loan. For example, additional information may disclose the interest rate of the loan. In some embodiments, renewal options may include permission or prohibition of a loan renewal. In some embodiments, prepayment may include a user-inputted integer associated with a monetary amount to be paid to the loan issuer before the loan amount is sent to a loan applicant. In some embodiments, loan options may also include the total loan amount. The loan application may be for a personal loan, business loan, or any other type of loan

In step 1050, a user may be able to view and/or select partner/firm portal preferences. In some embodiments, partner/firm portal preferences may include options that may make features accessible and/or active in an interactive website interface. In some embodiments, the options may include a portal access verification process section, a partner information file upload section, an option to send to an administrative user for approval, a Florida stamp tax information section, and an option to utilize a firm portal one-time password (OTP).

In step 1060, a user may be able to view and/or select PNC Private Bank Discounts. In some embodiments, PNC private bank discounts may include a discount in payment and/or interest for a user who may be PNC Private Bank clients. Generally, step 1060 may be an exclusive discount only offered to an eligible user who meets at least one criterion established by the lender of the loan or an administrative user.

In step 1070, a user may be able to view and/or select payment preferences. In some embodiments, payment preferences may include an option to select firm pay or partner pay. In embodiments, payment preferences may include an option to turn on or off a quarterly invoice and/or an annual summary.

In step 1080, a user may be able to view and/or select amortization preferences. Amortization preferences may include a proportion of a scheduled payment that may be used to pay interest and a proportion of a scheduled payment that may be used to pay principal balance. Amortization preferences may further include an amount equal to an amount owed on each payment date. In some embodiments, amortization preferences may include an option to generate an invoice. Further, there may be an option to select how many days in advance the invoice may be sent and how business day adjustment may be configured.

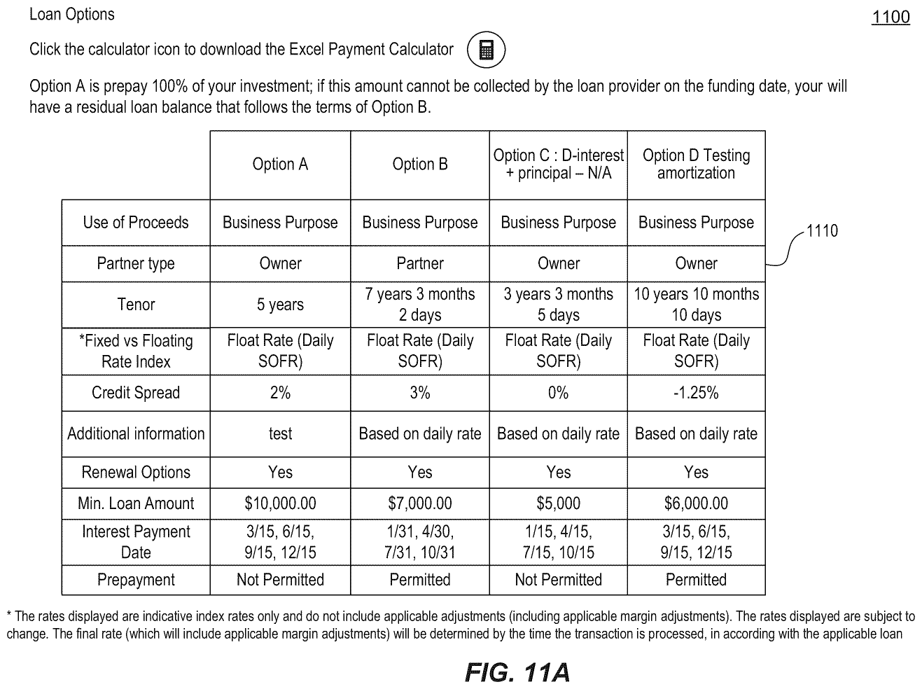

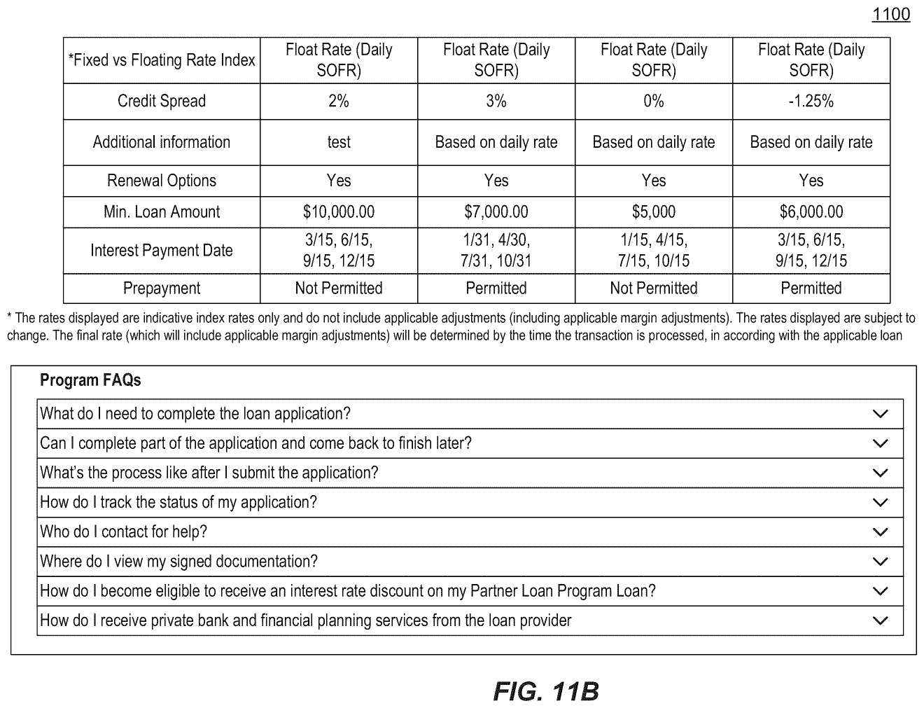

FIG. 11A illustrates an exemplary graphical user interface 1100 displaying comparative loan plan options. In some embodiments, graphical user interface 1100 may include an interactable portion that may take the form of a calculator icon and may be used to download a spreadsheet that may assist the user in calculating payment options (e.g., Excel Payment Calculator). In some embodiments, graphical user interface 1100 may include text that may inform a user the difference between loan options. In some embodiments, graphical user interface 1100 may include a table 1110 that may include at least one loan plan in the columns of the table and at least one loan characteristic in the rows of the table, or vice versa. In some embodiments, table 1110 may also include text that may describe or explain at least one cell of table 1110.

FIG. 11B illustrates an exemplary graphical user interface 1100 displaying a drop-down menu of frequently asked questions regarding the available loan plans. In some embodiments, a user may select a question from the drop-down menu to view the answer.

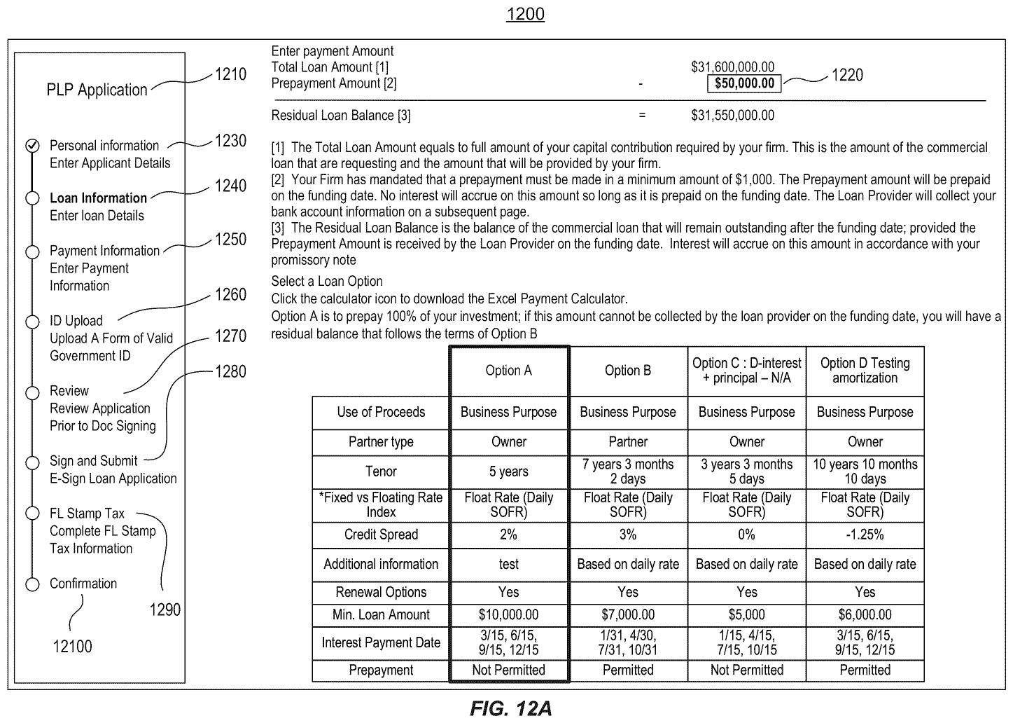

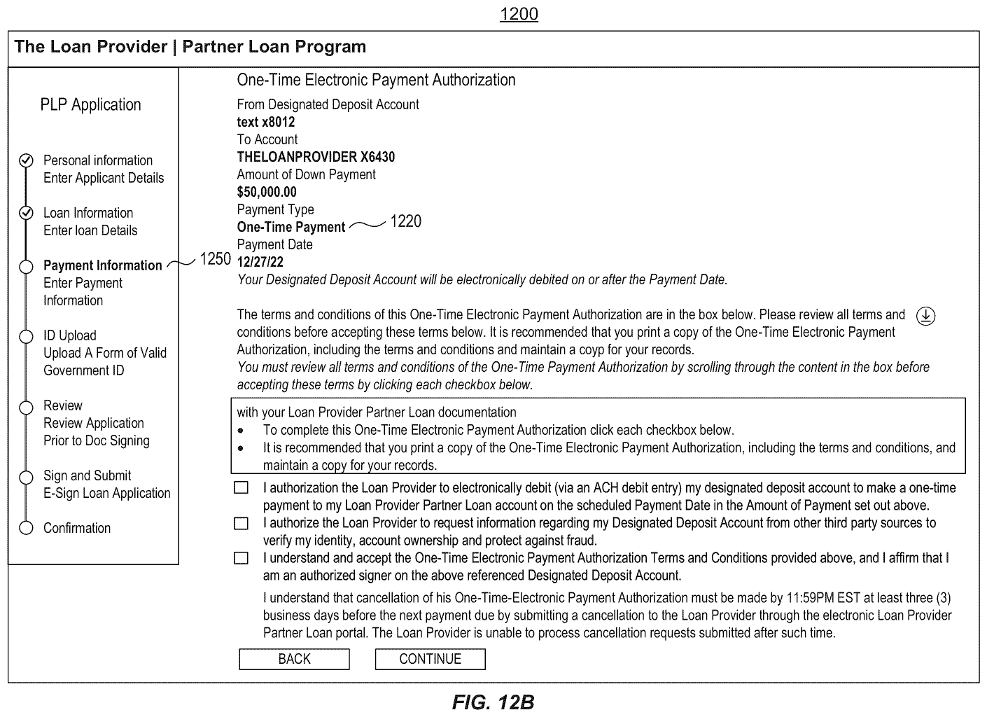

FIGS. 12A-12B illustrate an exemplary graphical user interface 1200 to visualize loan options information considering the Total Loan Amount, wherein the user can input a specified prepayment amount. In some embodiments, a menu 1210 may display steps a user may need to complete to complete their loan application and their current progress of completion of said steps.

In some embodiments, step 1230 may be Personal Information, which may include applicant details such as name, date of birth, citizenship status, country of residence, social security number, housing information, and monthly income. In some embodiments, at least one processor is further configured to determine in which state or jurisdiction a user resides. In some embodiments, the operations may further comprise determining whether the user is a Florida resident and requiring Florida stamp tax forms and information in step 1290. In some embodiments, at least one processor is further configured to update the website interface based on the user's state of residence.

In some embodiments, step 1240 may be Loan Information, which may include loan details such as total loan amount, table 1110, and a field 1220 that allows a user to input prepayment amount. FIG. 12A illustrates an exemplary graphical user interface to visualize loan information.

In some embodiments, step 1250 may be Payment Information, which may include an account from which a payment may be made, an account to which a payment may be made, an amount of payment equal to the prepayment amount entered in field 1220, payment type, payment date, terms and conditions of payment, a selection box that a user may use to confirm and authorize payment, a selection box that a user may use to authorize information requests to verify the authenticity of the designated deposit account, and a selection box that a user may use to acknowledge and accept said terms and conditions of payment. In some embodiments, the account from which a payment may be made is an authorized bank account. In some embodiments, a user may make a prepayment through the website interface. FIG. 12B illustrates an exemplary graphical user interface to visualize a One Time Payment Authorization of step 1250, wherein the user interface allows the user to authorize the lending party to perform actions and collect data required for the acceptance of the loan prior to the first deposit.

In some embodiments, step 1260 may be ID Upload, in which a user may upload a form government ID such as a driver's license, social security card, passport, passport card, state-issued identification card or military-issued identification card. In some embodiments, a form of government ID may not include any military identification. In some embodiments, the form of government ID may be manually verified by an individual associated with the lender of the loan.

In some embodiments, step 1270 may be Review, in which a user may review an application prior to document signing.

In some embodiments, step 780 may be Sign and Submit, in which a user may electronically sign an application.

In some embodiments, step 1290 may be Florida Stamp Tax, in which a user may complete Florida stamp tax information. Further, step 1290 may only appear for a user who is determined to be a Florida resident by at least one processor in step 1230. In some embodiments, step 1290 may provide a form to a user to complete confirming that the loan application is completed in Florida and that the user will be the required tax. In some embodiments, step 1290 may further provide a notary form to a user to complete to verify that the user will not pay the stamp tax and will sign the full document package out of state with a notary witness. In some embodiments, step 1290 may be configured to upload and receive a document from a user.

In some embodiments, step 12100 may be Confirmation, in which confirmation of application submission may be presented to a user. In some embodiments, a user may be able to download a signed and submitted version of their loan application.

It is to be understood that the disclosed embodiments are not necessarily limited in their application to the details of construction and the arrangement of the components and/or methods set forth in the following description and/or illustrated in the drawings and/or the examples. The disclosed embodiments are capable of variations, or of being practiced or carried out in various ways.

The disclosed embodiments may be implemented in a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods and computer program products according to various embodiments of the present invention. In this regard, each block in the flowcharts or block diagrams may represent a software program, segment, or portion of code, which comprises one or more executable instructions for implementing the specified logical function(s). It should also be noted that, in some alternative implementations, the functions noted in the block may occur out of the order noted in the figures. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1.-20. (canceled)

21. A system comprising:
a memory storing a set of instructions, the memory including a database configured to store data including:
a unique firm identifier associated with a partner company;
one or more identifying information data elements associated with the partner company;
one or more selectable service request options associated with the partner company;
one or more service request limitation elements associated with the partner company;
one or more portal preferences associated with the partner company;
one or more service request discount options associated with the partner company; and
one or more service request resolution preferences associated with the partner company;
at least one processor configured to execute the instructions to:
receive, from an endpoint device, a plurality of service requests including:
a request firm identifier, the request firm identifier being identical between each of the plurality of service requests;
one or more selectable service request option selections chosen from the one or more selectable service request options associated with the partner company;
one or more service request discount option selections chosen from the one or more service request discount options associated with the partner company; and
one or more service request resolution preference selections chosen from the one or more service request resolution preferences associated with the partner company;
authenticate the request firm identifier against the unique firm identifier to confirm that the plurality of service requests is associated with the partner company;
validate the one or more selectable service request option selections, the one or more service request discount option selections, and the one or more service request resolution preference selections against the one or more service request limitation elements associated with the partner company;
determine whether the validation is denied;
for each of the one or more selectable service request option selections for which the validation is denied:
flag as rejected the one or more selectable service request option selections, if at least one of the one or more selectable service request option selections was not validated against the one or more service request limitation elements;
flag as rejected the one or more service request discount option selections, if at least one of the one or more service request discount option selections was not validated against the one or more service request limitation elements;
flag as rejected the one or more service request resolution preference selections, if at least one of the one or more service request resolution preference selections was not validated against the one or more service request limitation elements;
provide for display on a user interface associated with the endpoint device a notification including any selectable service request option selections, service request discount option selections, and resolution preference selections flagged as rejected; and
provide for display on the user interface a request for revision to each of the plurality of service requests until none of the selectable service request option selections, service request discount option selections, or resolution preference selections is flagged as rejected;
approve, in response to the validation, the plurality of service requests; and
provide for display on the user interface a notification advising of the approval.

22. The system of claim 21, wherein the processor is further configured to:
determine an aggregate service request element by combining at least one of the one or more selectable service request option selections from each of the plurality of service requests; and
validate the aggregate service request element against the one or more service request limitation elements.

23. The system of claim 22, wherein the one or more service request limitation elements include a maximum debt level associated with the partner company and each of the at least one of the one or more selectable service request option selections from each of the plurality of service requests is a debt increase request value.

24. The system of claim 22, wherein at least one of the plurality of service requests includes at least one collateral proposal and the processor is further configured to validate the collateral proposal against the one or more service request limitation elements.

25. The system of claim 21, wherein the processor is further configured to provide for display on the user interface a plurality of interactive fields displaying each of the one or more selectable service request option selections, each of the one or more service request discount option selections, and each of the one or more service request resolution preference selections.

26. The system of claim 21, wherein each of the plurality of service requests includes a request for commercial debt increase.

27. The system of claim 26, wherein the processor is further configured to provide for display on the user interface a service request status table including a commercial debt repayment column.

28. The system of claim 27, wherein the service request status table further includes an approved commercial debt increase selection column.

29. The system of claim 28, wherein the service request status table further includes a commercial debt acknowledgement and request submission column.

30. The system of claim 21, wherein at least one of the one or more service request limitation elements is a company criteria and the processor is further configured to deny at least one of the plurality of service requests based on the company criteria.

31. A non-transitory computer readable medium including instructions that, when executed by at least one processor, cause the at least one processor to perform operations comprising:
receiving, from a database, a unique firm identifier associated with a partner company;
receiving, from the database, one or more identifying information data elements associated with the partner company;
receiving, from the database, one or more selectable service request options associated with the partner company;
receiving, from the database, one or more service request limitation elements associated with the partner company;
receiving, from the database, one or more portal preferences associated with the partner company;
receiving, from the database, one or more service request discount options associated with the partner company;
receiving, from the database, one or more service request resolution preferences associated with the partner company;
receiving, from an endpoint device, a plurality of service requests including:
a request firm identifier, the request firm identifier being identical between each of the plurality of service requests;
one or more selectable service request option selections chosen from the one or more selectable service request options associated with the partner company;
one or more service request discount option selections chosen from the one or more service request discount options associated with the partner company; and
one or more service request resolution preference selections chosen from the one or more service request resolution preferences associated with the partner company;
authenticating the request firm identifier against the unique firm identifier to confirm that the plurality of service requests is associated with the partner company;
validating the one or more selectable service request option selections, the one or more service request discount option selections, and the one or more service request resolution preference selections against the one or more service request limitation elements associated with the partner company;
determining whether the validation is denied;
for each of the one or more selectable service request option selections for which the validation is denied:
flagging as rejected the one or more selectable service request option selections, if at least one of the one or more selectable service request option selections was not validated against the one or more service request limitation elements;
flagging as rejected the one or more service request discount option selections, if at least one of the one or more service request discount option selections was not validated against the one or more service request limitation elements;
flagging as rejected the one or more service request resolution preference selections, if at least one of the one or more service request resolution preference selections was not validated against the one or more service request limitation elements;
providing for display on a user interface associated with the endpoint device a notification including any selectable service request option selections, service request discount option selections, and resolution preference selections flagged as rejected; and
providing for display on the user interface a request for revision to each of the plurality of service requests until none of the selectable service request option selections, service request discount option selections, or resolution preference selections is flagged as rejected;
approving, in response to the validation, the plurality of service requests; and
providing for display on the user interface a notification advising of the approval.

32. The non-transitory computer readable medium of claim 31, wherein the operations further comprise:
determining an aggregate service request element by combining at least one of the one or more selectable service request option selections from each of the plurality of service requests; and
validating the aggregate service request element against the one or more service request limitation elements.

33. The non-transitory computer readable medium of claim 32, wherein the one or more service request limitation elements include a maximum debt level associated with the partner company and each of the at least one of the one or more selectable service request option selections from each of the plurality of service requests is a debt increase request value.

34. The non-transitory computer readable medium of claim 32, wherein at least one of the plurality of service requests includes at least one collateral proposal and the operations further comprise validating the collateral proposal against the one or more service request limitation elements.

35. The non-transitory computer readable medium of claim 31, wherein the operations further comprise providing for display on the user interface a plurality of interactive fields displaying each of the one or more selectable service request option selections, each of the one or more service request discount option selections, and each of the one or more service request resolution preference selections.

36. The non-transitory computer readable medium of claim 31, wherein each of the plurality of service requests includes a request for commercial debt increase.

37. The non-transitory computer readable medium of claim 36, wherein the operations further comprise providing for display on the user interface a service request status table including a commercial debt repayment column.

38. The non-transitory computer readable medium of claim 37, wherein the service request status table further includes an approved commercial debt increase selection column.

39. The non-transitory computer readable medium of claim 38, wherein the service request status table further includes a commercial debt acknowledgement and request submission column.

40. The non-transitory computer readable medium of claim 31, wherein at least one of the one or more service request limitation elements is a company criteria and the operations further comprise denying at least one of the plurality of service requests based on the company criteria.
